(19) United States
(12) Patent Application Publication
(10) Pub. No.: US 2026/0291627 A1
(43) Pub. Date: Sep. 24, 2026

(54) EVALUATING IMPACT OF TWO SIMULATANEOUS MACHINE LEARNING EANBLED FEATURES

(71) Applicant: Nokia Technologies Oy, Espoo (FI)

(72) Inventors: Mahmood Reza ALIZADEH ASHRAFI, Espoo (FI); István Zsolt KOVÁCS, Aalborg (DK); Dimitri GOLD, Espoo (FI); Amaanat ALI, Espoo (FI); Sakira HASSAN, Espoo (FI)

(21) Appl. No.: 19/472,981

(22) PCT Filed: Apr. 18, 2024
(86) PCT No.: PCT/EP2024/060571

§ 371 Date: Oct. 6, 2025

(30) Foreign Application Priority Data
May 23, 2023 (GB) 2307738.1

(51) Int. Cl. H04B 17/27; H04B 17/391; H04L 43/0852; H04L 43/0888; H04W 24/10

(52) U.S. Cl. CPC H04B 17/27; H04B 17/3913; H04L 43/0852; H04L 43/0888; H04W 24/10

(57) ABSTRACT

An apparatus comprising: means for causing a user equipment to simultaneously perform two or more machine learning enabled features at the user equipment, for at least a period of time; means for receiving, from the user equipment, performance related information relating to the two or more machine learning enabled features; and means for using the received performance related information to evaluate, at the apparatus, an impact of the two or more machine learning enabled features being performed simultaneously at the user equipment for at least a period of time, the impact being on at least one of the two or more machine learning enabled features.

### FIELD

The present application relates to a method, apparatus, and computer program. In particular, but not exclusively, the present application relates to testing the impact of Machine Learning features at user equipment.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. Discussion of 6G networks has also begun.

### SUMMARY

According to a first aspect there is disclosed an apparatus comprising: means for causing a user equipment to simultaneously perform two or more machine learning enabled features at the user equipment, for at least a period of time; means for receiving, from the user equipment, performance related information relating to the two or more machine learning enabled features; and means for using the received performance related information to evaluate, at the apparatus, an impact of the two or more machine learning enabled features being performed simultaneously at the user equipment for at least a period of time, the impact being on at least one of the two or more machine learning enabled features.

According to some examples, the impact is measured on at least one key performance indicator of the at least one of the two or more machine learning enabled features.

According to some examples, causing a user equipment to simultaneously perform two or more machine learning enabled features comprises configuring one or more of the machine learning enabled features.

According to some examples, evaluating the impact of the two or more machine learning enabled features comprises evaluating an individual impact of each enabled feature on the user equipment, wherein the individual impact comprises an offset in a performance indicator specific to a first machine learning enabled feature and is caused by activation of at least a second machine learning enabled feature.

According to some examples, evaluating the impact of the two or more machine learning enabled features comprises evaluating a mutual impact of the two or more machine learning enabled features on the user equipment, wherein the mutual impact comprises an offset in a performance indicator common to at least two machine learning enabled features and is caused by activation of at least one further machine learning functionality.

According to some examples, the apparatus comprises means for sending one or more test signals to the user equipment for testing the two or more machine learning enabled features.

According to some examples, the one or more test signals comprise test data.

According to some examples, causing the user equipment to simultaneously perform two or more machine learning enabled features comprises causing the user equipment to any one of: test a first of the two or more machine learning enabled features whilst a second of the two or more machine learning enabled features is enabled for activity; test both of the two or more machine learning enabled features simultaneously; enable both of the two or more machine learning enabled features for activity simultaneously.

According to some examples, each of the two or more machine learning enabled features is arranged to perform inference related to one or more of: channel state information compression; channel state information prediction; user equipment positioning; user equipment mobility.

According to some examples, the performance related information comprises information on one or more of: throughput; latency or delays; processing power used.

According to some examples, the performance related information is received in one or more test reports.

According to some examples, the apparatus comprises a test equipment apparatus.

According to a second aspect there is provided an apparatus comprising at least one processor; and at least one memory storing instructions that, when executed by the at least one processor, cause the master node apparatus at least to perform: causing a user equipment to simultaneously perform two or more machine learning enabled features at the user equipment, for at least a period of time; receiving, from the user equipment, performance related information relating to the two or more machine learning enabled features; and using the received performance related information to evaluate, at an apparatus, an impact of the two or more machine learning enabled features being performed simultaneously at the user equipment for at least a period of time, the impact being on at least one of the two or more machine learning enabled features.

According to a third aspect there is provided an apparatus comprising: means for receiving configuration information from a test equipment; means for using the configuration information to simultaneously perform two or more machine learning enabled features at the apparatus for at least a period of time; means for generating performance related information of the two or more machine learning enabled features; and means for sending the performance related information to the test equipment.

According to some examples, the simultaneous performance of the two or more machine learning enabled features comprises configuring one or more of the machine learning enabled features for at least a period of time.

According to some examples, the apparatus comprises means for receiving one or more test signals from the test apparatus. According to some examples, the one or more test signals comprise test data.

According to some examples, the simultaneous performance of the two or more machine learning enabled features comprises any one of: testing a first of the two or more machine learning enabled features whilst a second of the two or more machine learning enabled features is enabled for activity; testing both of the two or more machine learning enabled features simultaneously; enabling both of the two or more machine leaning enabled features for activity simultaneously.

According to some examples, the apparatus comprises means for collecting usage statistics of the two or more machine learning enabled features for including in the performance related information that is sent to the test equipment.

According to some examples, the usage statistics comprise statistics relating to one or more of: processing load; memory usage.

According to some examples, each of the two or more machine learning enabled features is arranged to perform inference related to one or more of: channel state information compression; channel state information prediction; user equipment positioning; user equipment mobility.

According to some examples, the apparatus comprises means for sending the performance related information in one or more test reports.

According to some examples, the one or more test reports comprises separate test reports when at least some of the two or more machine learning enabled features share common test protocols and at least some of the two or more machine learning enabled features do not share common test protocols.

According to some examples, the apparatus comprises a user equipment.

According to a fourth aspect there is provided an apparatus comprising at least one processor; and at least one memory storing instructions that, when executed by the at least one processor, cause the apparatus at least to perform: receiving configuration information from a test equipment; using the configuration information to simultaneously perform two or more machine learning enabled features at an apparatus for at least a period of time; generating performance related information of the two or more machine learning enabled features; and sending the performance related information to the test equipment.

According to a fifth aspect there is provided a method, performed by an apparatus, comprising: causing a user equipment to simultaneously perform two or more machine learning enabled features at the user equipment, for at least a period of time; receiving, from the user equipment, performance related information relating to the two or more machine learning enabled features; and using the received performance related information to evaluate, at the apparatus, an impact of the two or more machine learning enabled features being performed simultaneously at the user equipment for at least a period of time, the impact being on at least one of the two or more machine learning enabled features.

According to some examples, the impact is measured on at least one key performance indicator of the at least one of the two or more machine learning enabled features.

According to some examples, causing a user equipment to simultaneously perform two or more machine learning enabled features comprises configuring one or more of the machine learning enabled features.

According to some examples, evaluating the impact of the two or more machine learning enabled features comprises evaluating an individual impact of each enabled feature on the user equipment, wherein the individual impact comprises an offset in a performance indicator specific to a first machine learning enabled feature and is caused by activation of at least a second machine learning enabled feature.

According to some examples, evaluating the impact of the two or more machine learning enabled features comprises evaluating a mutual impact of the two or more machine learning enabled features on the user equipment, wherein the mutual impact comprises an offset in a performance indicator common to at least two machine learning enabled features and is caused by activation of at least one further machine learning functionality.

According to some examples, the method further comprises sending one or more test signals to the user equipment for testing the two or more machine learning enabled features.

According to some examples, the one or more test signals comprise test data.

According to some examples, causing the user equipment to simultaneously perform two or more machine learning enabled features comprises causing the user equipment to any one of: test a first of the two or more machine learning enabled features whilst a second of the two or more machine learning enabled features is enabled for activity; test both of the two or more machine learning enabled features simultaneously; enable both of the two or more machine learning enabled features for activity simultaneously.

According to some examples, each of the two or more machine learning enabled features is arranged to perform inference related to one or more of: channel state information compression; channel state information prediction; user equipment positioning; user equipment mobility.

According to some examples, the performance related information comprises information on one or more of: throughput; latency or delays; processing power used.

According to some examples, the performance related information is received in one or more test reports.

According to some examples, the apparatus comprises a test equipment apparatus.

According to a sixth aspect there is provided a method, performed by an apparatus, comprising: receiving configuration information from a test equipment; using the configuration information to simultaneously perform two or more machine learning enabled features at the apparatus for at least a period of time; generating performance related information of the two or more machine learning enabled features; and sending the performance related information to the test equipment.

According to some examples, the simultaneous performance of the two or more machine learning enabled features comprises configuring one or more of the machine learning enabled features for at least a period of time.

According to some examples, the method comprises receiving one or more test signals from the test apparatus.

According to some examples, the one or more test signals comprise test data.

According to some examples, the simultaneous performance of the two or more machine learning enabled features comprises any one of: testing a first of the two or more machine learning enabled features whilst a second of the two or more machine learning enabled features is enabled for activity; testing both of the two or more machine learning enabled features simultaneously; enabling both of the two or more machine leaning enabled features for activity simultaneously.

According to some examples, the method comprises collecting usage statistics of the two or more machine learning enabled features for including in the performance related information that is sent to the test equipment.

According to some examples, the usage statistics comprise statistics relating to one or more of: processing load; memory usage.

According to some examples, each of the two or more machine learning enabled features is arranged to perform inference related to one or more of: channel state information compression; channel state information prediction; user equipment positioning; user equipment mobility.

According to some examples, the method comprises sending the performance related information in one or more test reports.

According to some examples, the one or more test reports comprises separate test reports when at least some of the two or more machine learning enabled features share common test protocols and at least some of the two or more machine learning enabled features do not share common test protocols.

According to some examples, the apparatus comprises a user equipment.

According to a seventh aspect there is provided a computer program comprising instructions, which when executed by an apparatus, cause the apparatus to perform at least the following: cause a user equipment to simultaneously perform two or more machine learning enabled features at the user equipment, for at least a period of time; receive, from the user equipment, performance related information relating to the two or more machine learning enabled features; and use the received performance related information to evaluate, at the apparatus, an impact of the two or more machine learning enabled features being performed simultaneously at the user equipment for at least a period of time, the impact being on at least one of the two or more machine learning enabled features.

According to an eighth aspect there is provided a computer program comprising instructions, which when executed by an apparatus, cause the apparatus to perform at least the following: receive configuration information from a test equipment; use the configuration information to simultaneously perform two or more machine learning enabled features at the apparatus for at least a period of time; generate performance related information of the two or more machine learning enabled features; and send the performance related information to the test equipment.

According to a ninth aspect there is provided a non-transitory computer readable medium comprising program instructions that, when executed by an apparatus, cause the apparatus to perform at least the following: causing a user equipment to simultaneously perform two or more machine learning enabled features at the user equipment, for at least a period of time; receiving, from the user equipment, performance related information relating to the two or more machine learning enabled features; and using the received performance related information to evaluate, at an apparatus, an impact of the two or more machine learning enabled features being performed simultaneously at the user equipment for at least a period of time, the impact being on at least one of the two or more machine learning enabled features.

According to a tenth aspect there is provided a non-transitory computer readable medium comprising program instructions that, when executed by an apparatus, cause the apparatus to perform at least the following: receiving configuration information from a test equipment; using the configuration information to simultaneously perform two or more machine learning enabled features at an apparatus for at least a period of time; generating performance related information of the two or more machine learning enabled features; and sending the performance related information to the test equipment.

### DESCRIPTION OF FIGURES

Embodiments will now be described, by way of example only, with reference to the accompanying Figures in which:

FIG. 1 schematically shows an example of a shared ML runtime environment;

FIG. 2 is a signalling diagram according to an example;

FIG. 3 is a signalling diagram according to an example;

FIG. 4 schematically shows a test environment according to an example;

FIG. 5 schematically shows a test environment according to an example;

FIG. 6 schematically shows a test environment according to an example;

FIG. 7 schematically shows a test environment according to an example;

FIG. 8 shows the principle of a performance impact assessment matrix;

FIG. 9 shows a schematic representation of a control apparatus according to some example embodiments;

FIG. 10 shows a schematic representation of an apparatus according to some example embodiments;

FIGS. 11 and 12 show flow charts according to some examples;

FIG. 13 shows a schematic representation of a non-volatile memory medium storing instructions which when executed by a processor allow a processor to perform one or more of the steps of the methods of some embodiments.

### DETAILED DESCRIPTION

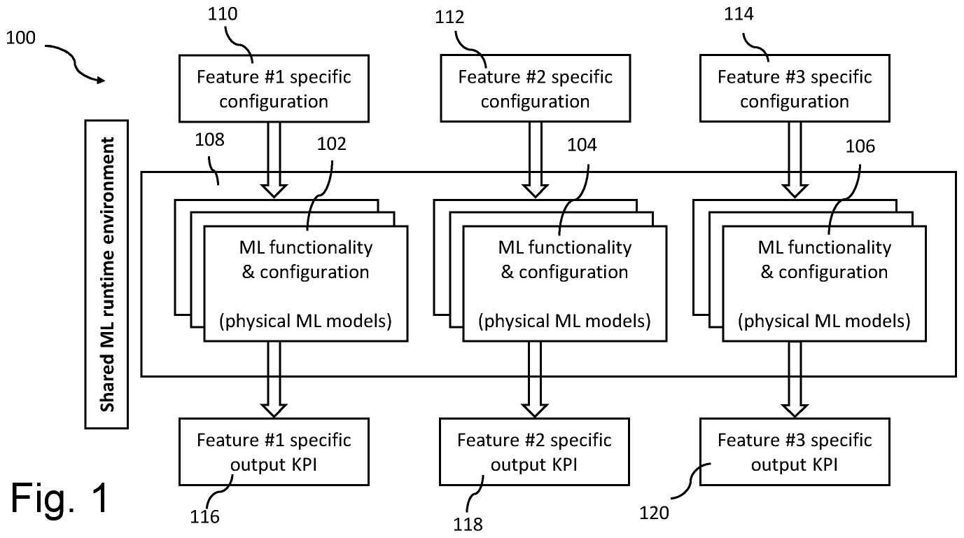

In the following, certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1 to assist in understanding the technology underlying the described examples.

3GPP NR Release 18 Study Item “AI/ML for air interface” explores the use of Artificial Intelligence (AI) and Machine Learning (ML) models to enhance wireless communication in 5G networks. The study item examines three use cases: CSI compression; CSI prediction; and beam management in time and spatial domains, as well as enhanced positioning. Testing requirements and approaches for AI/ML-enabled features, as well as defining AI/ML processing capabilities, are also discussed. Current research relates to optimizing ML algorithm training and inference for resource-constrained devices, such as “TinyML”, which could be applicable to UE ML implementation solutions.

UE testing setups for ML-assisted radio resource management (RRM) functionality are being developed, and new use cases such as mobility; channel sensing; prediction; ageing; and charting may be relevant to 5G-Advanced discussions in Rel-19. Testing and verification of ML-enabled use cases should be concurrent with their development, requiring a certain degree of gNB and UE cooperation. Determining methods to express UE and base station (BS) core and performance criteria, as well as the associated compliance testing of such solutions, may also be necessary.

ML models may operate based on providing an inference, for example an output, based on a combination of inputs. In general, ML models execute, run or operate in a power intensive manner. For example, the inference of the ML model may require more processing power, or may be working in an environment that provides a lot of computing power (e.g., a Graphical Processing Unit (GPU) hosting several gigabytes (GBs) of Radio Access Memory (RAM)), than what the UE implementation environment typically has available. Therefore, the ML inference phase may use significant resources and/or too much time for a specific service, due to the UE having limited ML computation resources available. The processing capability of a UE device plays a role in determining their ability to perform ML-enabled tasks. The new ML-enabled features and functionalities may be dependent on a shared pool of ML computational resources and therefore, concurrently active ML features might negatively impact each other.

In the present disclosure, the terms artificial intelligence (AI) and machine learning (ML) may be used interchangeably. For example, AI functionality may also be termed ML functionality, and vice versa.

The present disclosure identifies that there may be a benefit to identifying the mutual impact of ML functionalities supported by a UE. This may be for different use cases. For example, the present disclosure identifies that there may be a benefit to assessing the impact of, for example, a beam prediction ML algorithm in the time and/or spatial domain for an example use case X, and other ML functionalities supported by the same UE for other example use cases Y, Z, etc., (e.g., CSI compression, CSI prediction, positioning, etc.).

FIG. 1 shows an example of a device 100 (e.g., a UE) which is capable of, in this example, three different ML-enabled features (or use cases). For example, the different use cases may be CSI compression, beam prediction and enhanced positioning. These ML-enabled features may be implemented by means of one or more ML functionalities 102, 104, 106, each supported by one or more ML (physical) models. The physical ML models may be executed on an ML platform 108 (SW+HW) and share a finite pool of compute resources.

In some examples, the ML runtime environment in the UE 100 may comprise a set of computing resources which are ML specific. For example, the set of computing resources may include a set of GPU(s); a set of Central Processing Units (CPUs); a number of gigabytes (GB) of RAM; a set of specialized hardware accelerators performing specialized functions (e.g., use case specific Field Programmable Gate Arrays (FPGA)/Application-Specific Integrated Circuit (ASIC)/Tensor Processing Unit (TPU) implementation resources that are required to be shared by a set of ML enabled use-cases/features).

Each high-level use case/feature may support one or more functionalities. For example, a beam prediction feature/use case may support beam prediction in time and spatial domain functionalities. Similarly, if ML enabled positioning is the high-level feature/use case, direct AI/ML positioning and AI/ML assisted positioning functionalities may be supported. For example, in direct AI/ML positioning, the AI/ML algorithm is utilized to render a UE's position directly. In the assisted case, AI/ML algorithms assist existing algorithms by improving the current positioning techniques.

Each functionality may require a specific configuration to be provided to the UE under test. In FIG. 1, the configurations are schematically shown at 110, 112 and 114. In some examples, configuration implies the signalling aspects and the network resources required to support the use case (e.g., positioning reference signals, downlink/uplink RS, etc.). Hence, corresponding to each functionality that is supported for a given use case, there is a configuration and a corresponding set of Key Performance Indicators (KPIs) that may be applicable to the given use case. In FIG. 1, output KPIs are schematically shown at 116, 118 and 120. For example, for a beam prediction use case, this could be the latency of reporting (of measured and/or predicted beams in milliseconds); the accuracy of prediction for the Top K beams; accuracy of the predicted Reference Signal Received Power (RSRP); accuracy pertaining to the prediction window for the time domain beam prediction; accuracy of prediction corresponding to given beam IDs etc. In a further example, for a positioning use case, the output KPI could be latency of the positioning measurement (in milliseconds) and positioning accuracy (e.g., in centimetres).

As discussed above, current ML-enabled use cases specified in RAN1, if supported by UE and gNB, should be testable and verifiable. As a result, ML-enabled use cases may be concurrent with the development of ML-enabled RAN1 solutions, which may require a certain degree of gNB and UE co-operation. Determining methods to express UE and BS core and performance criteria, as well as the associated compliance testing of such solutions may also be necessary. Mobile Network Operators (MNOs) may use these specifications and mechanisms as a reference for performance testing and verification before allowing or turning on new functions in their live networks.

The processing capability of UE devices plays a role in determining a UE's ability to enable and perform ML-enabled tasks. For Layer 1-Layer 3 procedures, to ensure the UE's ability to perform (near) real-time inference and other on-device decision-making processes, its ML-related processing capabilities may be in/directly identified and indicated, e.g., via capability reporting mechanisms. For example, it should be known when the UE is capable of and/or expected to handle several ML-enabled features simultaneously.

In the current RAN4-5 testing setup, only one feature at a time is tested to ensure its compliance with the requirements. In other words, all features are tested individually. One reason for this approach is because traditional radio features, i.e., non-ML features, may be readily distinguishable from each other by solely observing the corresponding configurations.

The present disclosure identifies that the testing model should evolve when ML-enabled features are engaged, due to the new requirements on ML-type compute resources in the UEs. The new ML-enabled features and functionalities may be dependent on, and may utilize, a shared pool of ML computational resources, such as processing units like CPUs, GPUs, TPUs, etc., throughout the life cycles (training and inference). Therefore, concurrently active ML features might negatively impact each other. The UE vendor may implement a dedicated compute resource management algorithm to mitigate this. However, as identified in the present disclosure, the RAN4-5 testing framework should be able to verify that the UE performance requirements are met under the condition of simultaneous active ML-enabled feature/functionalities.

Therefore, some examples herein address how to assess the mutual impact of ML functionalities that are supported by a UE for a given use case X (e.g., beam prediction in time/spatial domain) on other ML functionalities that are supported by the same UE for another use case Y, Z etc., (e.g., CSI compression, CSI prediction, positioning, etc.).

As will be discussed in more detail below, the present disclosure describes an ML-enabled functionality testing framework. In some examples, multiple UE ML enabled features are active simultaneously in the UE that is under test. Where impact of two or more machine learning enabled features being performed simultaneously at the user equipment is discussed, it will be understood that this encompasses that the impact could be zero (i.e. no impact). Of course, it also encompasses that there could be an impact i.e., the impact is non-zero.

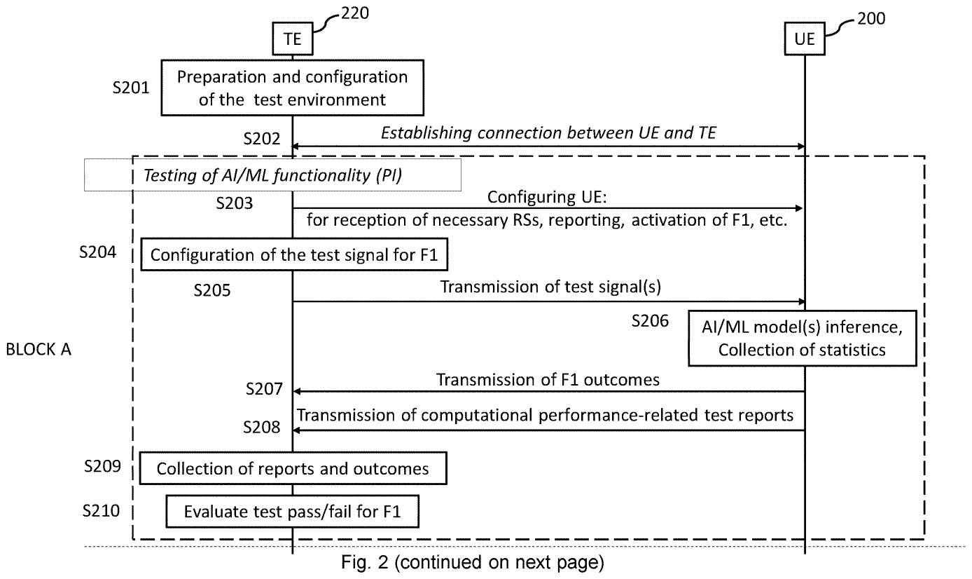

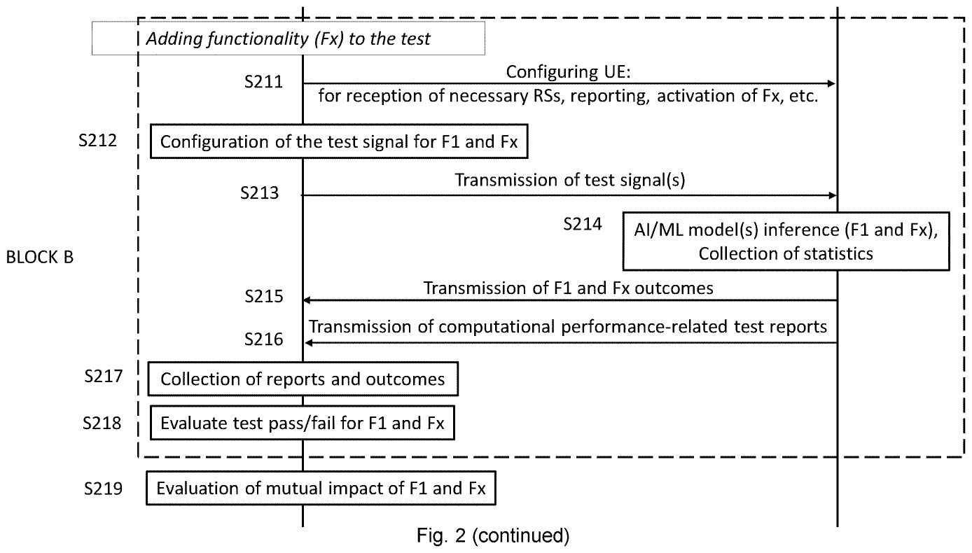

Reference is made to FIG. 2, which is a signalling diagram showing communication between a UE 200 and a testing/test equipment (TE) 220. The testing equipment may be e.g. a base station or another network element. In FIG. 2, “Block A” shows testing of AI/ML functionality F1, and “Block B” shows adding ML functionality (Fx) to the test environment.

S201 shows preparation and configuration of the test environment.

S202 shows communication between the UE 100 and the TE 120 being established. Block A is then entered.

At S203, the TE configures the UE 200. For example, the TE 220 configures the UE 200 for reception of necessary reference signals (RSs) e.g. SSB or CSI-RS. For example, the TE 220 configures the UE 200 for activation of ML functionality. For example, the UE may be configured for a first ML functionality F1. For example, the TE 220 configures the UE 200 for reporting to the TE 220. For example, the TE 220 configures the UE 200 for sending of performance metrics and/or one or more test reports.

At S204, the test signal for functionality F1 is configured at TE 220.

At S205, one or more test signals are transmitted from TE 220 to UE 200.

At S206, the UE 200 performs inference based on the one or more test signals. At this stage, the UE 200 may also collect performance statistics. In some examples, it may be considered that the inference phase is when the AI/ML algorithm is deployed and works with “real-world” data, unlike for example the training phase where both data (observations) and labels (ground truth) are known. In inference time or period, labels are not known, and AI/ML algorithm has to predict those.

At S207, outcomes are transmitted from UE 200 to TE 220. For example, when the test signal is a CSI-RS pattern, the outcome is CSI feedback. When the test signals are the SSB pattern, then the outcome is the SSB-RSRP.

At S208, the UE 200 transmits performance related metrics to TE 220. For example, one or more test reports may be sent. For example, the performance related metrics or test reports indicate e.g. the estimated accuracy of the outcome, and/or the computational effort required to derive the outcome.

As shown at S209, test reports and outcomes are collected at TE 220.

Then, at S210 the TE evaluates whether the UE has passed or failed the test for ML functionality F1. For example, it may be determined whether UE 200 has met a threshold performance level (e.g. amount of processing resource used/remaining) while F1 is active at the UE. The threshold may be preconfigured and/or based on simulations, for example.

In the example of FIG. 2, the method then proceeds to Block B, which shows a stress-testing approach when one or several AI/ML enabled functionalities are added during the test.

At S211, the TE 220 configures UE 200. For example, TE 220 configures UE 200 for reception of new or further RSs (e.g. CSI-RS) specific to testing the second ML functionality. For example, the simultaneously active ML functionalities can share the inputs such as CSI-RS, but generate different type of outputs (predictions, labels). For example, the TE 220 configures UE 200 for activation of a new or further ML functionality Fx. For example, Fx is in addition to F1. For example, TE 220 configures UE 200 for sending performance metrics and/or one or more test reports.

At S212, the TE 220 configures test signals for F1 and Fx.

At S213, the TE 220 transmits one or more test signals to UE 200, for F1 and/or Fx.

At S214, the UE 200 performs inference using the AI/ML models F1 and/or Fx. At this stage, the UE 200 may also perform collection of statistics. For example, the statistics may comprise usage statistics. By way of non-limiting example, the usage statistics may relate to processing load or memory usage.

At S215, the UE 200 transmits F1 and Fx outcomes to the TE 220.

At S216, the UE 200 transmits performance-related metrics and/or one or more test reports of UE performance to TE 220.

At S217, the TE 220 collects the received outcomes and one or more test reports.

At S218, the TE evaluates whether the UE has passed or failed the test for ML functionality F1 and functionality Fx. For example, it may be determined whether UE 200 has met a threshold performance level (e.g. amount of processing resource used/remaining) while F1 and Fx are active at the UE. Traditional performance metrics may also be assessed, e.g. throughput and latency, determined under a condition of F1 and Fx being simultaneously active. The threshold may be preconfigured and/or based on simulations, for example.

By way of non-limiting example, assessing passing or failing may be as follows.
Testing based on the individual feature performance when ML features are executed/performed simultaneously:
   For example, if the requirement defines that certain prediction (e.g. beam or CSI report) should be reported within Xms, and UE reports the prediction at X+yms, then the test is failed
   In another example, the time of prediction may not be defined, but the requirement is on the performance of the feature. If the prediction cannot be made in time, then whether previous or some random value will be used. Then the performance will be degraded. For example, if the reported predicted value is above the given thresholds/limits (for one or several times, e.g., over 5% of time), then the test can be assumed to be failed
Testing based on feature mutual impact
   This can be based on model intermediate KPIs (such as prediction quality/accuracy not measured but provided by the model itself, load of the computational units in the device, memory usage, etc.) then if these value are above defined thresholds then the test is failed.

At S219, the TE 220 then evaluates the mutual impact of F1 and Fx on the performance of UE 200. This may comprise information related to e.g. performance evaluation matrix, as will be described later.

Therefore, from FIG. 2 it can be seen that initially only one ML functionality (F1) is tested. In some examples, F1 is tested first to check the traditional performance KPIs (e.g. throughput and latency). Additionally, when available, the reported/collected computation performance related metrics (S216) can also be tested. However, in some examples, the traditional performance KPI values are known in which case block A may be skipped.

At some point of time T1, another AI-ML functionality Fx is configured for testing together with F1. In the example of FIG. 2, configuration includes both identification of new configuration to the UE (S211), changes in the transmitted test signals (S212 and S213 where, e.g. new Reference Signals (RS) can be added such as CSI-RS in addition to SSB), and also UE reporting configuration (S216, e.g., for the purpose of the test UE can be configured with additional reports that demonstrate the computation load on AI/ML related processing components such as memory usage, CPU/GPU/TPU load, etc.).

In some examples, if the test is failed at S210, or S218, e.g., functionalities' outcomes are not acceptable, then the whole test is treated as “Failed”.

In some examples, in S219, the TE 220 evaluates the mutual impacts F1 and Fx.

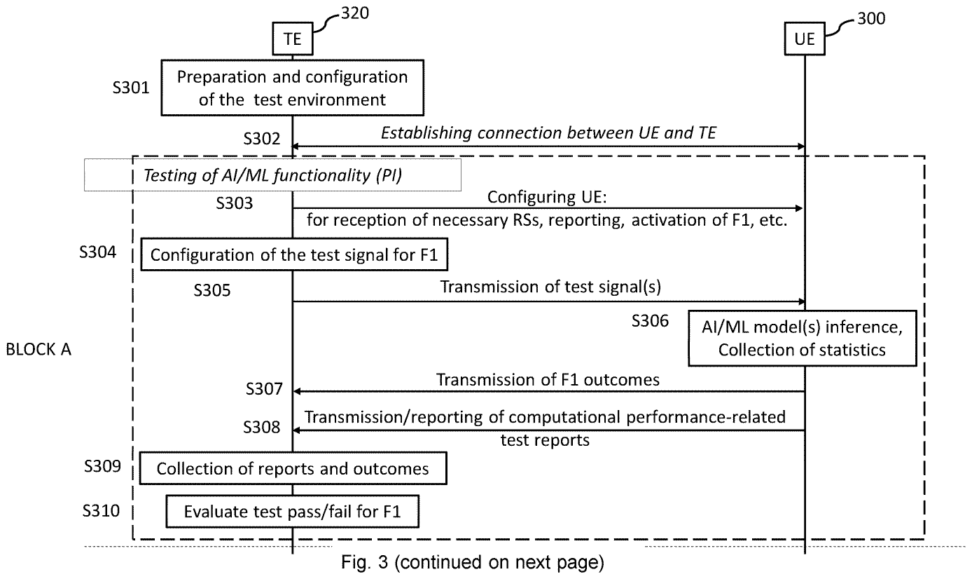

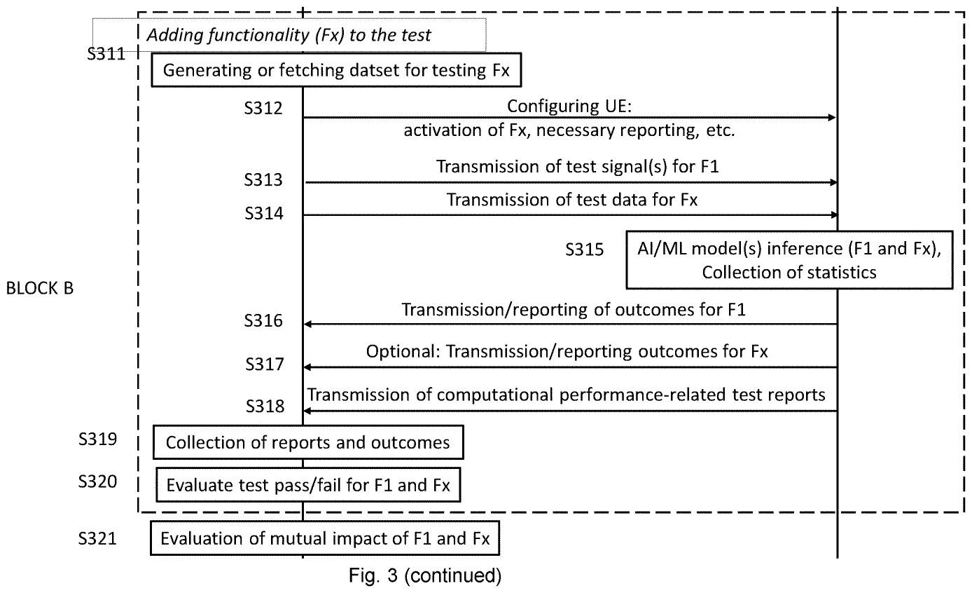

Another example of simultaneous testing of AI/ML enabled functionalities is shown in FIG. 3, which is a signaling diagram showing communication between a UE 300 and a TE 320. The TE may be a base station or another network element, for example. In some examples, UE 300 and TE 320 may be the same UE and TE as in FIG. 2.

S301 to S310 (Block A) is the same as in FIG. 2 and is therefore not discussed in further detail here, for conciseness.

Again, Block B shown an example where a functionality Fx is added. However, Block B in FIG. 3 differs from Block B in FIG. 2.

As shown at S311, the TE 320 generates or fetches a dataset for testing functionality Fx.

At S312, the TE 320 configures the UE 300. For example, the TE 320 configures the UE 300 for activation of Fx and necessary reporting.

At S313, the TE 320 transmits one or more test signals for functionality F1.

At S314, the TE 320 transmits the generated dataset for functionality Fx.

At S315, the UE 300 performs AI/ML model inference for F1 and Fx.

At S316, the UE 300 transmits or reports outcomes for F1.

At S317, the UE 300 optionally transmits or reports outcomes for Fx.

At S318, the UE 300 transmits performance related metrics and/or one or more test reports.

At S319, the TE 320 collects the received outcomes and/or one or more test reports.

At S320, the TE 320 evaluates whether the UE has passed the test for F1 and Fx.

At S321, the TE 320 performs evaluation of the mutual impact of F1 and Fx. This may comprise information related to e.g. performance evaluation matrix, as will be described later.

Therefore, in summary, a difference between the example of FIG. 3 and the example of FIG. 2 is that in the example of FIG. 3 Fx is not tested fully i.e., based on the radio signal transmitted from the test equipment. For example, in FIG. 3, additional load is generated for the functionality F1 that is executed in parallel to Fx. To run Fx, test data (or dataset) is prepared in S311 and sent from the TE 320 to the UE 300 in S314. In some examples, S314 can be a one-time or a periodic operation. In a practical example, a dataset containing positioning reference symbol (PRS) samples is used for an ML-enabled positioning algorithm (Fx). So in FIG. 3 the TE does not transmit PRS explicitly, but provides data sets with generated PRS samples, e.g. from multiple transmission points as scenarios are difficult to replicate in lab testing conditions.

Another practical example is where the dataset contains RSRP samples and Fx is a beam prediction algorithm.

In one example, testing data is provided to the UE 300 on application level over the physical downlink shared channel (PDSCH). One alternative is to provide testing dataset to the UE 300 at the beginning of the test, as a part of initial configuration (e.g. at S301). In another example, the UE 300 can generate test data on its own, e.g., Fx is activated in a test mode.

In some examples, the outcomes of functionality Fx based on the testing dataset can be reported in addition to the outcomes of F1 back to the TE (S316 and S317). However, if Fx is activated just to provide additional computational load at the UE, reporting may not be needed.

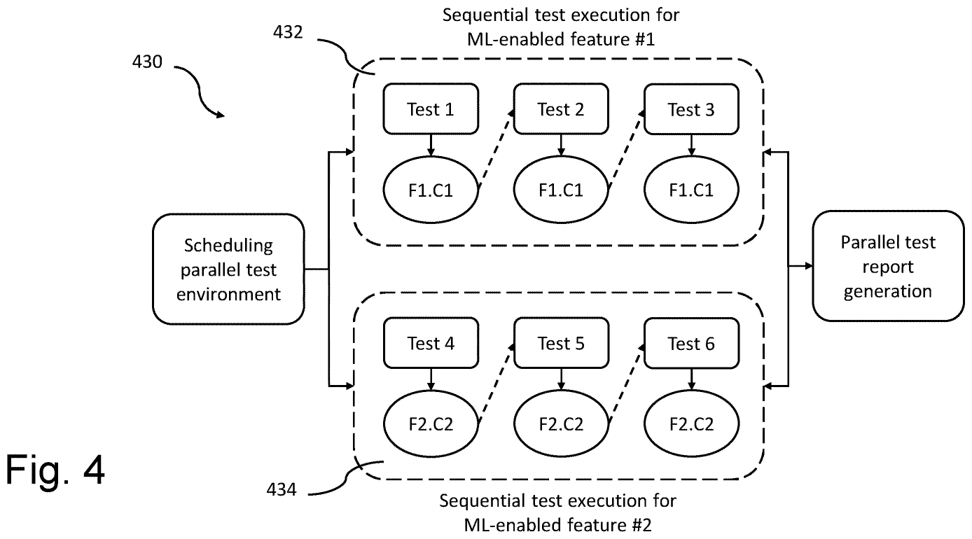

Some example test procedures will now be further elaborated upon with reference to FIGS. 4 to 7.

In one example shown in FIG. 4, a test environment is schematically shown at 430. A TE configures and schedules the parallel test environment 430, with two or more ML-enabled features or functionalities. In the example of FIG. 4, first ML feature is schematically shown at 432, and second ML feature is schematically shown at 434. ML features 432 and 434 are activated and being tested in parallel. In some examples, by “activated” is meant that the ML feature is configured, enabled and running, rather than (for example) not running or not configured or not enabled.

It is noted that the TE may not be able to control when exactly the ML algorithm is executed at the UE, so it cannot fully enforce simultaneous execution (down to nano second precision). The TE can however activate both ML features, provide the necessary test signals, and configure the UE reports for both (possibly simultaneously). In this way the two ML features can be said (assumed) to be active simultaneously.

In FIG. 4, F1=ML feature 1; F2=ML feature 2 (corresponding to Fx in FIGS. 2 and 3); C1=test condition 1; C2=test condition 2. A test condition may also be considered a test configuration. For example, a test configuration may be test signals transmitted/provided by the TE.

As shown in FIG. 4, each feature is tested three times. Of course, this is by way of example only and in other examples each feature may be tested more or fewer than three times.

In examples, the test conditions, configurations (F1.C1 and F2.C2), and sequences of the different ML-enabled features in the UE are handled independently.

In examples, after all test sequences have finished, a parallel test report is generated. In examples, the parallel test report gives a report on the impact or effect of F1 and F2 running in parallel or simultaneously. In some examples, individual test reports of the impact on the UE of each ML feature independently may be generated.

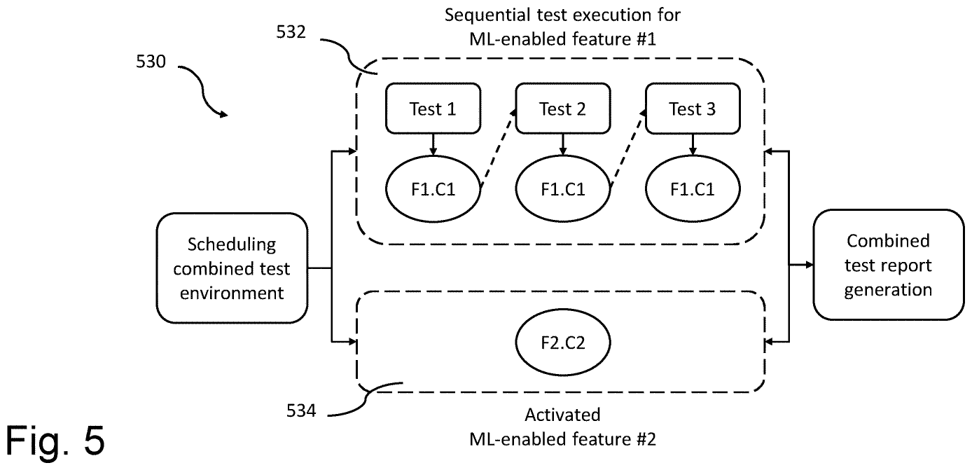

FIG. 5 shows a test environment 530. A first ML feature F1 is schematically shown at 432, and a second ML feature F2 is schematically shown at 434. In FIG. 5, F1=ML feature 1; F2=ML feature 2 (corresponding to Fx in FIGS. 2 and 3); C1=test condition 1; C2=test condition 2.

In the example of FIG. 5, F1 is being tested. F2 is activated, but not being tested. In some examples, “activated” may be considered to mean configured, enabled and running. The example of FIG. 5 may be considered a combined test environment.

Therefore, in the example of FIG. 5, the test conditions, configurations (F1.C1), and sequence are scheduled to apply only to one ML-enabled feature under test.

The other, one or more selected ML-enabled features are configured (F2.C2) and activated without a test sequence being triggered for them.

After the test sequence has finished, a combined test report is generated.

In some examples, the test is repeated with a new configuration F2.C2 for the not tested ML-enabled feature(s) F2. For example, F2 can be activated with a different configuration C2, while only the F1 is begin tested. It can happen that with C2 the F2 requires more compute power compared than with C1, hence the performance of F1 might be impacted by F2.C2 but not with F2.C1.

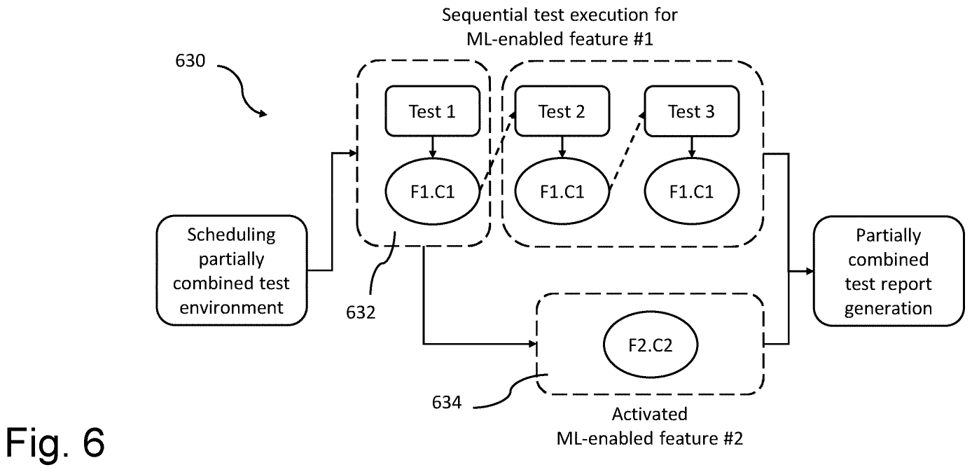

FIG. 6 shows a test environment 630. A first ML feature F1 is schematically shown at 632, and a second ML feature F2 is schematically shown at 634. In FIG. 6, F1=ML feature 1; F2=ML feature 2 (corresponding to Fx in FIGS. 2 and 3); C1=test condition 1; C2=test condition 2; C3=test condition 3.

The example of FIG. 6 may be considered a partially combined test environment and report generation. ML feature F2 is not being tested but is activated only after Test 1 of ML-enabled feature F1.

In this example, the test equipment configures and schedules the partially combined test environment, with two or more ML-enabled features F1 and F2 configured and activated, and only one of them being tested at a time.

Therefore, the test conditions, configurations (F1.C1), and sequence are scheduled to apply only to one ML-enabled feature under test.

The other one or more selected ML-enabled features F2 are configured (F2.C3) without a test sequence being triggered for them After a pre-defined test sequence/number has been executed, one or more of the other selected ML-enabled features are activated. In the example of FIG. 6, after Test 1 is complete on F1, F2 is activated while continuing to simultaneously perform test 2 and test 3 for F1. Therefore, in the example of FIG. 6, Test 2 and Test 3 for F1 are conducted with F2 also running.

After the test sequence has finished, a combined test report is generated.

In some examples, the Test(s) can be repeated with a new configuration F2.C3 for the not tested ML-enabled feature(s) F2.

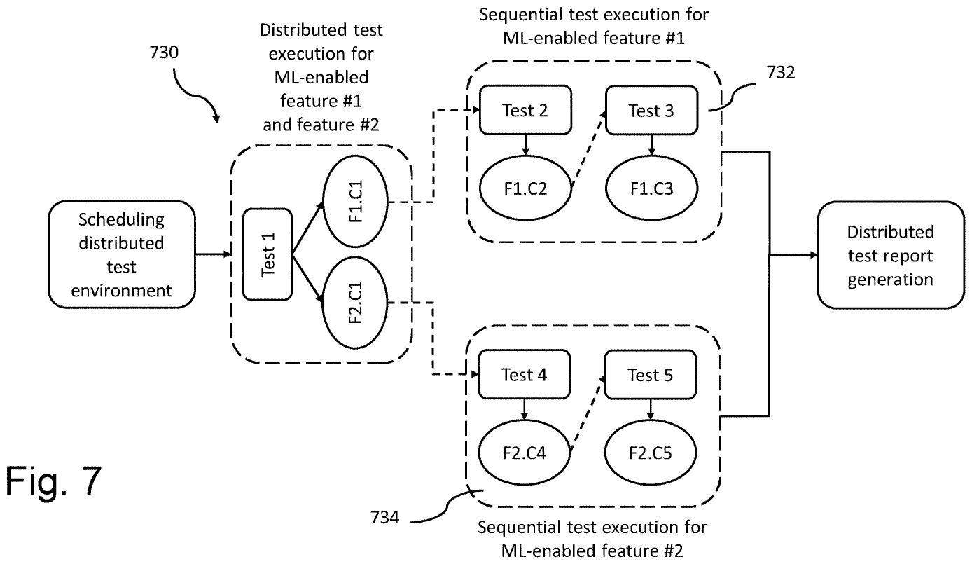

FIG. 7 shows a test environment 730. A first ML feature F1 is schematically shown at 732, and a second ML feature F2 is schematically shown at 734. In FIG. 7, F1=ML feature 1; F2=ML feature 2 (corresponding to Fx in FIGS. 2 and 3); C1=test condition 1; C2=test condition 2; C3=test condition 3; C4=test condition 4; C5=test condition 5.

FIG. 7 shows an example where the two or more ML features F1 and F2 can be tested together, in combination with a separate test. For example, at Test 1, F1 and F2 are tested together. In Test 2 and Test 3 F1 is tested, and in Test 4 and Test 5 F2 is tested. In some examples, Test 2 and Test 3 for F1 are carried out in parallel or simultaneously with Test 4 and Test 5 for F2.

In the example of FIG. 7, the test equipment configures and schedules a distributed or separate environment for multiple features (F1.C1, F1.C2, F2.C1, F2.C4), where some features share the common test protocols (cases), while the others follow parallel or sequential approaches

The test conditions, configurations (F1.C1, F1.C2, F2.C1, F2.C4), and sequences of the different ML-enabled features in the UE are handled in distributed or separate manner.

The same test conditions, configurations, and sequences for multiple ML-enabled features in the UE are being scheduled in parallel. For instance, F1.C1, F2.C1 are being scheduled together.

In the consecutive steps, if no common configurations (F1.C2, F2.C4) are found among the multiple features, then these are scheduled separately or even parallelly after receiving the previously scheduled tests. For example, the idea is that the test conditions/configuration for F1.C1 and F2.C1 are the same, hence they are executed as Test 1. Then for F1.C2 and F2.C4 the configurations are different, and separate/distributed tests are executed at Test 2 and Test 4. The same concept applies for Test 3 and Test 5

After all test sequences have finished, a distributed test report is generated, in addition to the individual test reports.

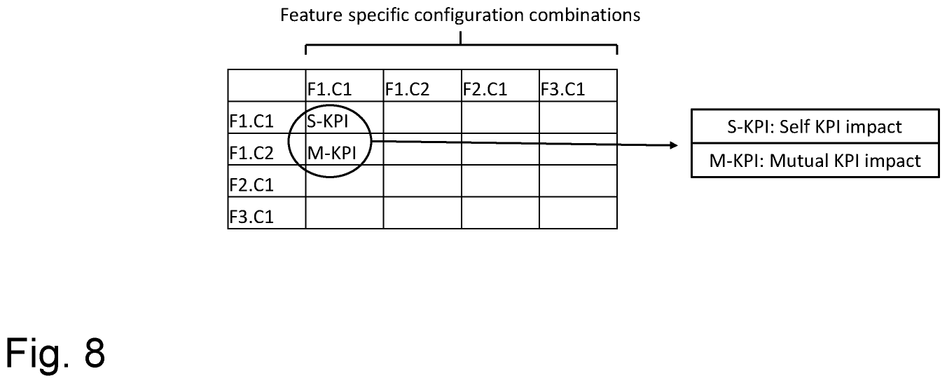

Based on the example shown in FIG. 1, when each ML enabled feature 102, 104, 106 is configured and running in the UE 100 it may be envisaged that there will be an impact to the other ML enabled feature(s) that are configured and running as well. To assess the performance impact a combination matrix (which may also be referred to as a performance evaluation matrix) may be used, for example as shown in FIG. 8. The combination matrix of FIG. 8 captures the impact in two dimensions—self and mutual.

In some examples it may be considered that the self-impact is the impact to the feature key performance indicator (KPI) due to the activation of another ML enabled feature(s).

In some examples it may be considered that the mutual-impact is to a feature KPI that is mutually defined for a pair of use cases e.g., beam prediction v/s positioning or beam prediction v/s CSI prediction. An example of mutual KPI in both these pairs of use cases could be the impact to inference latency e.g., the inference latency may be impacted for given Feature X due to shared resource usage or some scheduling constraints from Feature Y or Z.

In some examples, the KPIs can be the same for mutual and self-impact estimation. For self-impact the degradation of the KPIs may be recorded when any other ML enabled feature is activated. In some examples the mutual impact is only recorded for the KPIs mutually defined to be valid for two or more selected features. For example, reporting delay or inference latency may be valid for most or all use cases for both self- and mutual impact.

According to some examples, a throughput KPI can be used to estimate mutual impact for CSI compression and beam selection, but cannot be used to estimate mutual impact for Positioning and CSI compression.

As an example, when only ML positioning is configured and running in the UE the accuracy and latency of the positioning could be e.g., 95% and 20 msec respectively. However, when CSI prediction is configured at the same time it may also happen that the accuracy of the ML positioning drops to e.g., 90% (due to for instance missed/discarded input) and latency increases to 22 msec. In this case the testing will reveal not only the self KPI (as part of normal feature testing) but also the impact to the self KPI (due to this mutual testing). In this case, the matrix row corresponding to the functionality combination for positioning and CSI prediction will record −5% and +2 msec respectively from the perspective of the ML positioning feature. A mutual KPI of inference latency could be agreed for this example wherein the reason for the increased 2 msec latency may be tracked. For example, it may be considered whether the increased latency was due to the ML model suffering a latency due to the sharing of the ML environment, or something else.

Based on the foregoing, it will be appreciated that a ML-enabled testing functionality is provided where multiple UE ML enabled features are active simultaneously in the UE. In some examples, by “simultaneous” is meant that the two or more machine learning enabled features are both active simultaneously for at least a period of time. In other words, it may be considered that they are both active for at least an overlapping period of time. In some examples, simultaneous does not necessarily mean that each of the two or more machine learning enabled features is enabled (and potentially disabled) at exactly the same time. In some examples, during a test one or more of the two or more machine learning enabled features may be disabled for a period of time. The following lists some of features relevant to the proposed embodiments.
System Simulator (SS)/Test Equipment (TE)/Testing Setup (TS) which has a capability to enable/disable/activate/deactivate simultaneously or consecutively one or more AI/ML enabled features/functionalities at the UE.
SS/TE/TS has a capability to deliver ML models supporting one or more AI/ML enabled features/functionalities to the UE, e.g., in the case of two-sided ML model use cases such as CSI compression
   i. To fetch multiple UE AI/ML models from the external source and/or prepare those for deployment at the UE
   ii. If needed, to train multiple ML models based on (generated/external/provided) dataset
SS/TE/TS has a capability to generate or fetch from an external source the dataset for one or more AI/ML models and/or AI/ML-enabled features/functionalities and deliver those to the UE
System Simulator (SS)/Test Equipment (TE)/Testing Setup (TS) has a capability to configure test signals (e.g., enabled/disable multiple reference signals) simultaneously or consecutively as necessary for the execution of one or more AI/ML enabled features/functionalities
Scheduling (configuration and execution) of the parallel, combined, or distributed test environments, collection of AI/ML Model/Functionality/Feature usage statistics, and generation of the corresponding test reports
Estimate a performance impact (e.g., assessment matrix), including quantitative evaluation of self-impact and mutual impact of simultaneously activated AI/ML Models/Functionalities/Features.
   i. The impact can be evaluated by the TE based on the outputs feedbacked by the UE to the TE
   ii. The combination of the output and test reports can be used, specific to the scheduled test environments
The UE may need to support special AI/ML stress testing mode, in which it can collect and report computational load-specific statistics. In some examples the stress testing mode is activated by TE as a part of the test.

Based on the capabilities described above, the disclosure has proposed several ways to test simultaneously multiple AI/ML-enabled models/Functionalities/Features at the UE and their mutual impact:
Testing data (or datasets) for each of AI/ML Models/Functionalities are delivered to the UE. AI/ML Models/Functionalities are activated and executed in parallel. Inference is done based on data delivered from the TE.
Test Conditions and Test Equipment (TE)/System Simulator (SS) are configured in such a way that the UE can get necessary input data for inference of several AI/ML Models/Functionalities/Features from the test signal. For example, the UE may be expected to perform radio signal measurements e.g. CSI-RS or SSB which are transmitted in the test signal. The UE can use the collected signal samples as input to the ML model, with or without additional pre-processing, filtering etc.
Or a combination of the two approaches above. One or several AI/ML models/functionalities/features are executed based on the input from test signal. Additional computational load can be generated based on activation of one or more AI/ML Model(s)/Functionalities(s)/Feature(s) and their execution based on generated data/dataset either transmitted to the UE from TE or generated at UE directly (e.g., dummy data for background load).

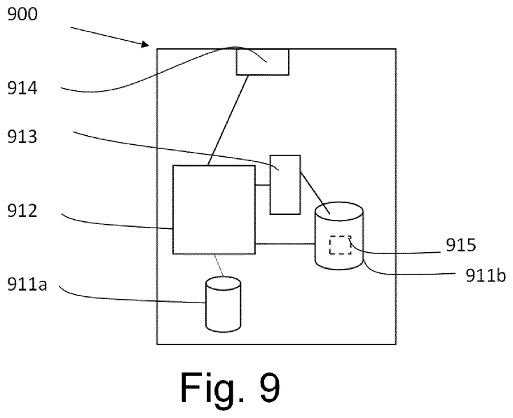

FIG. 9 illustrates an example of a control apparatus 900. The control apparatus may comprise at least one random access memory (RAM) 911a, at least on read only memory (ROM) 911b, at least one processor 912, 913 and an input/output interface 914. The at least one processor 912, 913 may be coupled to the RAM 911a and the ROM 911b. The at least one processor 912, 913 may be configured to execute an appropriate software code 915. The software code 915 may for example allow to perform one or more steps to perform one or more of the present aspects. The software code 915 may be stored in the ROM 911b. For example, a Test Equipment (TE) may be in the form of control apparatus 900.

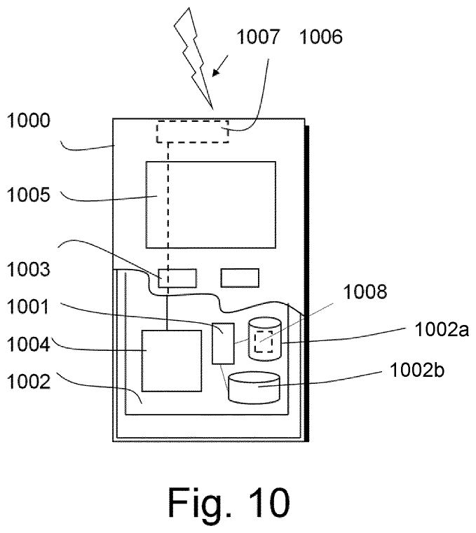

FIG. 10 illustrates an example of a terminal 1000. For example, the terminal 1000 may be the UE 200, 300 of above described FIGS. 2 and 3, respectively. The terminal 1000 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 1000 may provide, for example, communication of data for carrying communications. The communications may be one or more of voice, electronic mail (email), text message, multimedia, data, machine data and so on.

The terminal 1000 may be provided with at least one processor 1001, at least one memory ROM 1002a, at least one RAM 1002b and other possible components 1003 for use in software and hardware aided execution of tasks it is designed to perform, including control of access to and communications with access systems and other communication devices. The at least one processor 1001 is coupled to the RAM 1002b and the ROM 1002a. The at least one processor 1001 may be configured to execute an appropriate software code 1008. The software code 1008 may for example allow to perform one or more of the present aspects. The software code 1008 may be stored in the ROM 1002a.

The processor, storage and other relevant control apparatus can be provided on an appropriate circuit board and/or in chipsets. This feature is denoted by reference 1004. The device may optionally have a user interface such as keypad 1005, touch sensitive screen or pad, combinations thereof or the like. Optionally one or more of a display, a speaker and a microphone may be provided depending on the type of the device.

The terminal 1000 may receive signals over an air or radio interface 1007 via appropriate apparatus for receiving and may transmit signals via appropriate apparatus for transmitting radio signals. In FIG. 10 transceiver apparatus is designated schematically by block 1006. The transceiver apparatus 1006 may be provided for example by means of a radio part and associated antenna arrangement. The antenna arrangement may be arranged internally or externally to the mobile device.

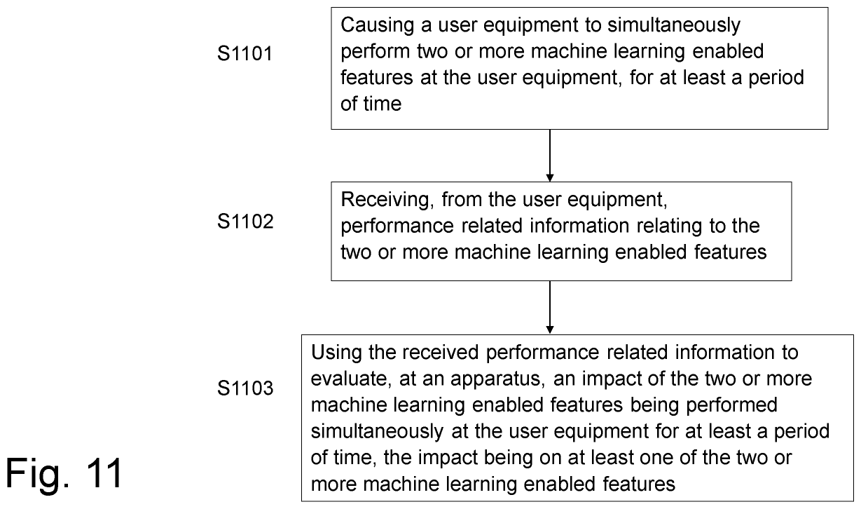

FIG. 11 is a flow chart of a method according to an example. The flow chart of FIG. 11 is viewed from the perspective of an apparatus. For example, the apparatus may comprise a test equipment apparatus.

As shown at S1101, the method comprises causing a user equipment to simultaneously perform two or more machine learning enabled features at the user equipment, for at least a period of time.

As shown at S1102, the method comprises receiving, from the user equipment, performance related information relating to the two or more machine learning enabled features.

As shown at S1103, the method comprises using the received performance related information to evaluate, at the apparatus, an impact of the two or more machine learning enabled features being performed simultaneously at the user equipment for at least a period of time, the impact being on at least one of the two or more machine learning enabled features.

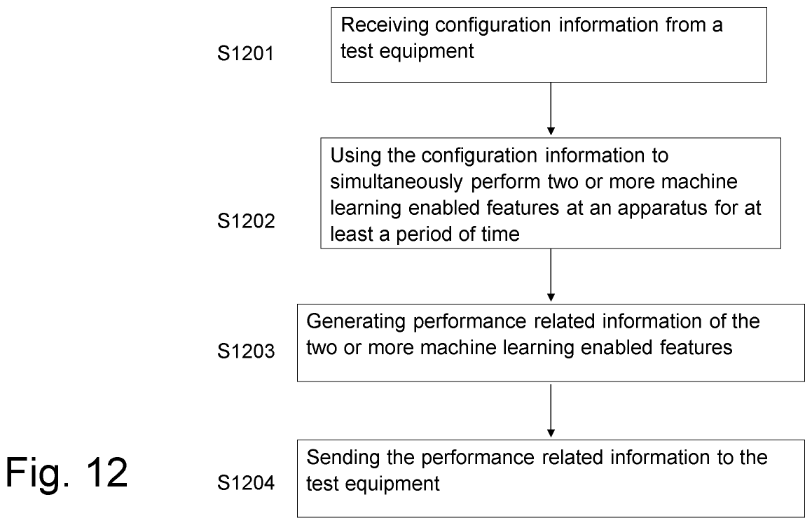

FIG. 12 is a flow chart of a method according to an example. The flow chart of FIG. 12 is viewed from the perspective of an apparatus. For example, the apparatus may comprise a User Equipment.

As shown at S1201, the method comprises receiving configuration information from a test equipment.

As shown at S1202, the method comprises using the configuration information to simultaneously perform two or more machine learning enabled features at an apparatus for at least a period of time.

As shown at S1203, the method comprises generating performance related information of the two or more machine learning enabled features.

As shown at S1204, the method comprises sending the performance related information to the test equipment.

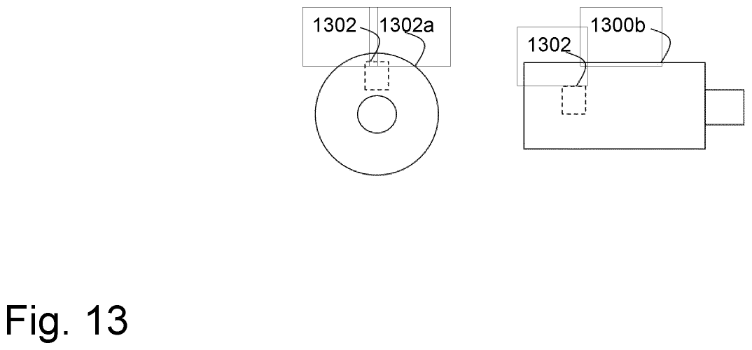

FIG. 13 shows a schematic representation of non-volatile memory media 1300a (e.g. computer disc (CD) or digital versatile disc (DVD)) and 1300b (e.g. universal serial bus (USB) memory stick) storing instructions and/or parameters 1302 which when executed by a processor allow the processor to perform one or more of the steps of the method of FIG. 11 or 12. It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-25. (canceled)

26. An apparatus comprising at least one processor and at least one memory storing instructions that, when executed by the at least one processor, cause the apparatus at least to:
cause a user equipment to simultaneously perform two or more machine learning enabled features at the user equipment, for at least a period of time;
receive, from the user equipment, performance related information relating to the two or more machine learning enabled features; and
use the received performance related information to evaluate, at the apparatus, an impact of the two or more machine learning enabled features being performed simultaneously at the user equipment for at least a period of time, the impact being on at least one of the two or more machine learning enabled features.

27. The apparatus according to claim 26, wherein the impact is measured on at least one key performance indicator of the at least one of the two or more machine learning enabled features.

28. The apparatus according to claim 26, wherein the causing the user equipment to simultaneously perform two or more machine learning enabled features comprises configuring one or more of the machine learning enabled features.

29. The apparatus according to claim 26, wherein evaluating the impact of the two or more machine learning enabled features comprises evaluating an individual impact of each enabled feature on the user equipment, wherein the individual impact comprises an offset in a performance indicator specific to a first machine learning enabled feature and is caused by activation of at least a second machine learning enabled feature.

30. The apparatus according to claim 26, wherein evaluating the impact of the two or more machine learning enabled features comprises evaluating a mutual impact of the two or more machine learning enabled features on the user equipment, wherein the mutual impact comprises an offset in a performance indicator common to at least two machine learning enabled features and is caused by activation of at least one further machine learning functionality.

31. The apparatus according to claim 26, wherein the apparatus is further caused to send one or more test signals to the user equipment for testing the two or more machine learning enabled features.

32. The apparatus according to claim 31, wherein the one or more test signals comprise test data.

33. The apparatus according to claim 26, wherein causing the user equipment to simultaneously perform two or more machine learning enabled features comprises causing the user equipment to any one of: test a first of the two or more machine learning enabled features whilst a second of the two or more machine learning enabled features is enabled for activity; test both of the two or more machine learning enabled features simultaneously; enable both of the two or more machine learning enabled features for activity simultaneously.

34. The apparatus according to claim 26, wherein each of the two or more machine learning enabled features is arranged to perform inference related to one or more of: channel state information compression; channel state information prediction; user equipment positioning; user equipment mobility.

35. The apparatus according to claim 26, wherein the performance related information comprises information on one or more of: throughput; latency or delays; processing power used.

36. The apparatus according to claim 26, wherein the performance related information is received in one or more test reports.

37. An apparatus comprising at least one processor and at least one memory storing instructions that, when executed by the at least one processor, cause the apparatus at least to:
receive configuration information from a test equipment;
use the configuration information to simultaneously perform two or more machine learning enabled features at the apparatus for at least a period of time;
generate performance related information of the two or more machine learning enabled features; and
send the performance related information to the test equipment.

38. The apparatus according to claim 37, wherein the simultaneous performance of the two or more machine learning enabled features comprises configuring one or more of the machine learning enabled features for at least a period of time.

39. The apparatus according to claim 37, wherein the apparatus is further caused to receive one or more test signals from the test apparatus.

40. The apparatus according to claim 39, wherein the one or more test signals comprise test data.

41. The apparatus according to claim 37, wherein the simultaneous performance of the two or more machine learning enabled features comprises any one of: testing a first of the two or more machine learning enabled features whilst a second of the two or more machine learning enabled features is enabled for activity; testing both of the two or more machine learning enabled features simultaneously; enabling both of the two or more machine learning enabled features for activity simultaneously.

42. The apparatus according to claim 37, wherein the apparatus is further caused to collect usage statistics of the two or more machine learning enabled features for including in the performance related information that is sent to the test equipment.

43. The apparatus according to claim 42, wherein the usage statistics comprise statistics relating to one or more of: processing load; memory usage.

44. The apparatus according to claim 37, wherein each of the two or more machine learning enabled features is arranged to perform inference related to one or more of: channel state information compression; channel state information prediction; user equipment positioning; user equipment mobility.

45. The apparatus according to claim 37, wherein the apparatus is further caused to send the performance related information in one or more test reports, where the one or more test reports comprises separate test reports when at least some of the two or more machine learning enabled features share common test protocols and at least some of the two or more machine learning enabled features do not share common test protocols.
